(19) United States
(12) Patent Application Publication
(10) Pub. No.: US 2009/0084911 A1
(43) Pub. Date: Apr. 2, 2009

(54) Machine Stand

(75) Inventors: Laurenz Bergmann, Haren/Erns (DE); Ingo Blekker, Uelsen (DE); Juergen Evers, Spelle (DE); Thomas Meelker, Twist (DE); Klaus Raasch, Geeste (DE)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Metabowerke GmbH, Nurtingen (DE)

(21) Appl. No.: 12/331,134

(22) Filed: Dec. 9, 2008

Related U.S. Application Data
(63) Continuation of application No. PCT/EP2007/003845, filed on May 2, 2007.

(30) Foreign Application Priority Data
Jun. 12, 2006 (DE) 20 2006 009 307.9

(51) Int. Cl. F16M 11/24; F16M 11/00

(52) U.S. Cl. 248/157; 248/440.1

(57) ABSTRACT

The subject matter of the invention is a machine stand with an elongated support body and support legs arranged at the ends on the support body, the support body being designed with positive engagement means running in the longitudinal direction, such that attachments, in particular at least one machine holder, optionally displaceable in the longitudinal direction, can be attached thereto. According to the invention, this machine stand is characterized in that the support body is embodied in one piece as a double-pipe profile, with two profile pipes running parallel to one another with lateral spacing from one another, and at least one center ridge connecting the profile pipes.

The invention relates to a machine stand having the features of the preamble of claim 1.

Machine stands of the type under consideration are known in a variety of embodiments. The known machine stand on which the invention is specifically based (U.S. Pat. No. 5,836,365) serves for securely arranging and mounting a miter saw on a platform, which, in turn, is fastened on an elongate support body of the machine stand by means of two machine holding devices provided on the underside. It is thereby possible to work with the miter saw, or other power tool, at a working height that corresponds to a standard work-bench in a work-room. The machine stand, as a portable device, replaces to a certain extent the work-bench in the workshop.

On the elongate support body of the known machine stand, there are respectively arranged at the ends two support legs, which, when positioned for use, are directed obliquely outwards in the form of a trapezoid. Consequently, the machine stand is highly stable. Respectively two support legs are jointly mounted in a pivotable manner in a bracket, made of sheet metal, at the end of the support body. When positioned for use, each support leg bears on a stop of the support-leg mounting constituted by the bracket, and is locked there. For this purpose, the support leg carries a locking element, which runs on an arcuate track of the bracket and is spring-biased into a locked position. In an initial position, with an orientation approximately parallel to the support body, the support leg is likewise latched on the track by the locking element, through spring bias. It is therefore necessary for each support leg to be released individually from the initial position, to enable it to be swiveled into the position of use.

Each support leg is realized as a single steel tube, and has a rubber foot at its lower end.

The support body, as a torsionally stiff backbone of the machine stand, is realized in one piece, as a hollow profile of extrusion-molded light metal, in particular aluminum. An extension profile can be inserted by sliding into the hollow chamber of the support body, by means of which extension profile an auxiliary stand can be attached to the actual machine stand, extending the latter.

The support body itself is designed with positive fit means extending in the longitudinal direction, namely a plurality of T-rails, in such a way that add-on parts, in particular the already mentioned machine holding devices for the platform of the power tool, in particular of the miter saw, can be attached to it so as to be displaceable in the longitudinal direction. Other add-on parts, in addition to the machine holding devices for the platform of the miter saw, can also be attached to these T-rails of the support body. These are, for example, workpiece supports, by means of which a long workpiece can be supported at the level of the workpiece support table of the miter saw, and longitudinal stops for such a workpiece.

Also known is a similar machine stand (EP-A-1,275,476), which has a carrying handle on the underside of the support body, and whose support body is realized in one piece, as a double-tube profile having two profile tubes, of non-round inner cross-section, extending in parallel to each other. It is thereby possible for an extension tube, of likewise non-round outer cross-section, to be inserted by sliding into each of the two profile tubes, such that the support body of the machine stand can be extended towards both ends by drawing out the extension tubes.

Finally, there is known (DE-A-103 03 115) the practice, on the one hand, of providing the support legs with extensions that can be drawn out, and, on the other hand, of providing one pair of support legs at one end of the support body with laterally projecting transport rollers.

The known machine stands are very usable in practice. It has been found, however, that the design of various aspects of the known machine stands is not yet optimal. Consequently, the invention is based on the problem of creating a machine stand that is optimized in various respects.

For the following explanations, references to horizontal and vertical, longitudinal direction and transverse direction are to be understood in the case of an erected machine stand, i.e. in the position of use, unless otherwise stated.

A first teaching of the invention relates to the machine stand having the features of the preamble of claim 1, which is characterized by the features of the characterizing portion of claim 1. The design of the support body in one piece, as a double-tube profile having a cross-section similar to the form of a dumb-bell, results in a particularly high flexural strength of the support body. In addition, very high operating loads can be accommodated by this machine stand. This, particularly expediently, is by means of an extruded profile made of aluminum.

Preferred designs and developments constitute subject-matter of the thereto appertaining dependent claims.

A double function is realized by the positive fit means according to claim 7. If the positive fit means on the support body are, at least on its top side, realized as inwardly extending longitudinal grooves, then, on the one hand, they are positive fit means for the attachment of add-on parts, on the other hand they in themselves create the non-round inner cross-section of the support body, in particular of the profile tubes of the double-tube profile.

The design of claim 10 is recommended for the arrangement of the extension tubes in the profile tubes. This realization is of independent significance.

The sliding contact bearing sleeve for a profile tube, defined in claim 10, can be combined with a closing cap in the case of a double-tube profile for the adjacent profile tube, in particular can be realized in one piece from plastic.

According to claim 13, the sliding contact bearing sleeve can also assume further functions, in particular those of fixing the extension tube in position in relation to the profile tube.

Claims 14 ff. are also of independent significance. Described therein is how, in the case of the machine stand according to the invention, the add-on parts can be attached in a particularly expedient manner, and how the add-on parts themselves can be realized in a particularly expedient manner.

Further, claims 30 ff. are also of particular and independent significance, which claims describe the machine stand more fully in respect of the particularly expedient designs of the clamping mechanism of the add-on parts, in particular of the machine holding devices.

Further, the features of claims 40 ff. are of particular and independent significance. These claims describe particularly expedient designs of the support legs and of corresponding support-leg mountings of the machine stand according to the invention.

Further, claims 51 ff. are of particular and independent significance, which claims have as their subject-matter a particular type of design of the machine stand having transport rollers.

The machine stand according to the invention, in all its variants, is explained more fully in the following with reference to a drawing representing merely exemplary embodiments.

In the explanation of the exemplary embodiments with reference to the drawing, also and in particular explained in detail are all advantages and effects of various features of the machine stand according to the invention. In the drawing

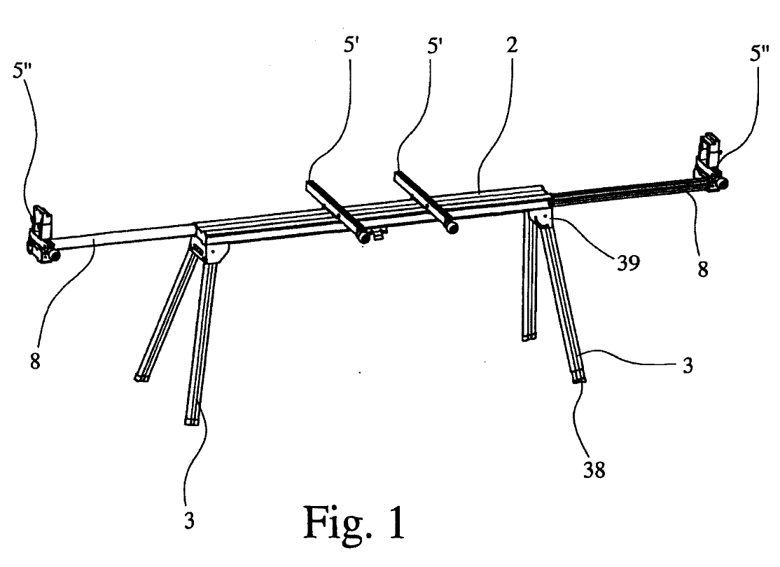

FIG. 1 shows, in a perspective view, an exemplary embodiment of a machine stand according to the invention, without mounted-on power tool,

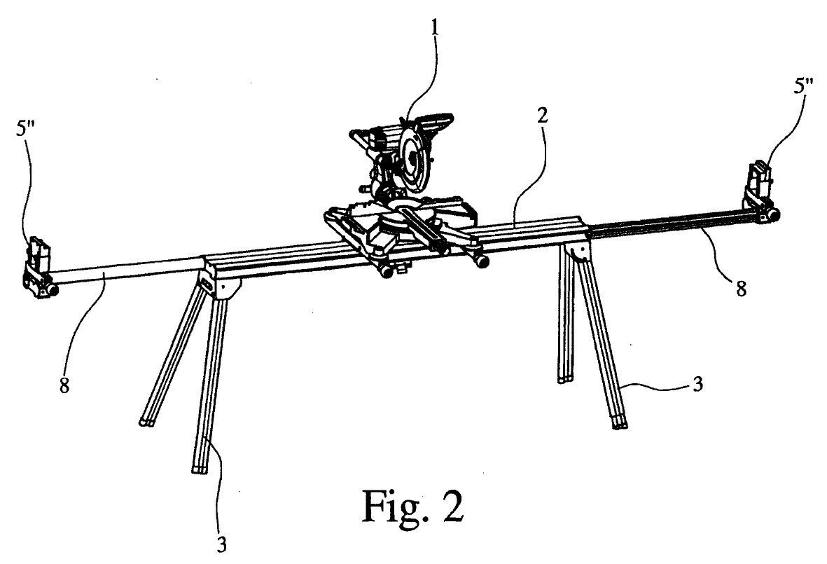

FIG. 2 shows, in a representation corresponding to FIG. 1, the machine stand from FIG. 1, now with a mounted-on power tool, namely a miter saw,

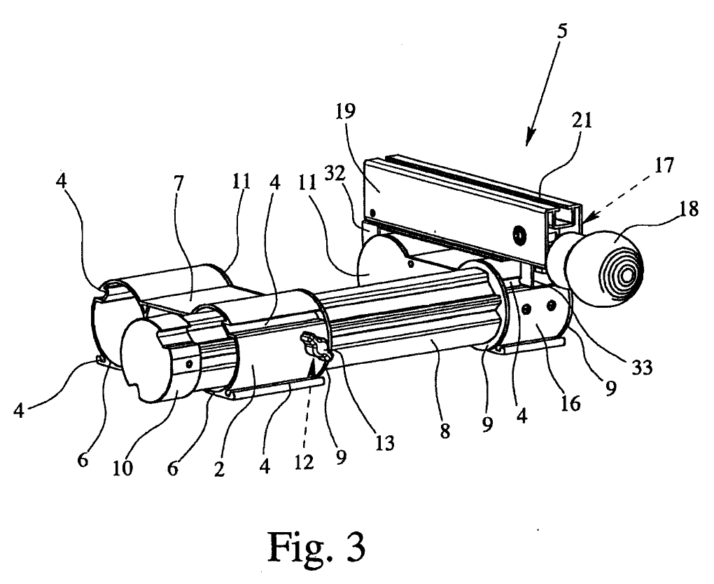

FIG. 3 shows, in a perspective view, the end of the support body of a machine stand according to FIG. 1, with partially drawn-out extension tube attached thereto,

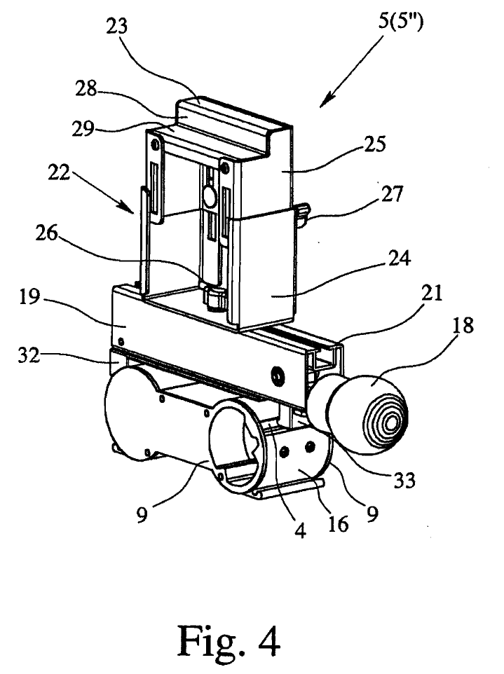

FIG. 4 shows, in a perspective view, a workpiece support as an add-on part of a machine stand of the type under consideration,

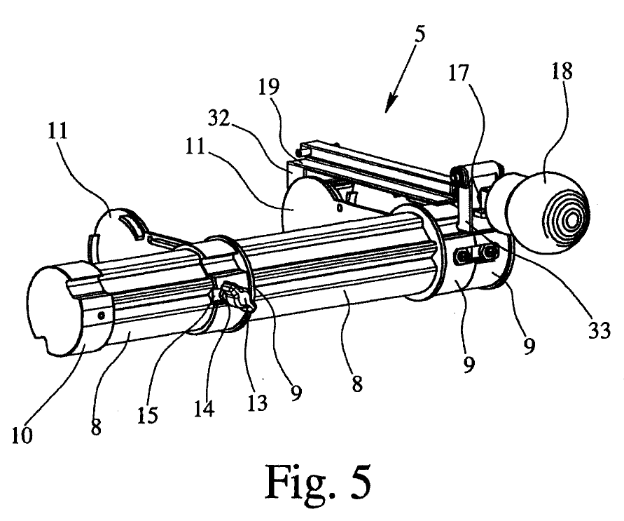

FIG. 5 shows, in a representation similar to FIG. 3, the clamping mechanism of a workpiece support according to FIG. 4,

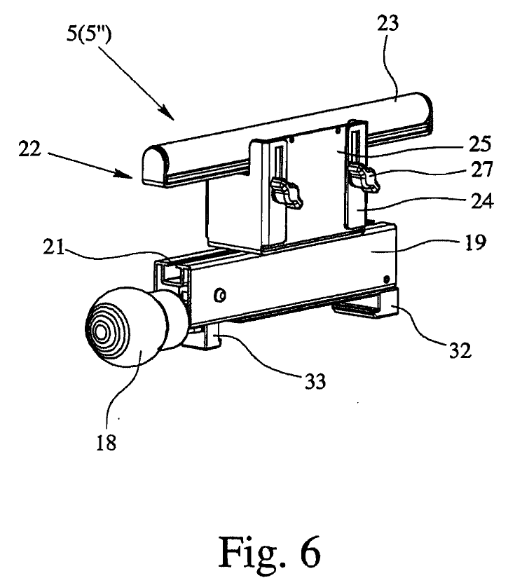

FIG. 6 shows, in a perspective view, a further exemplary embodiment of a workpiece support, here with a supporting roll,

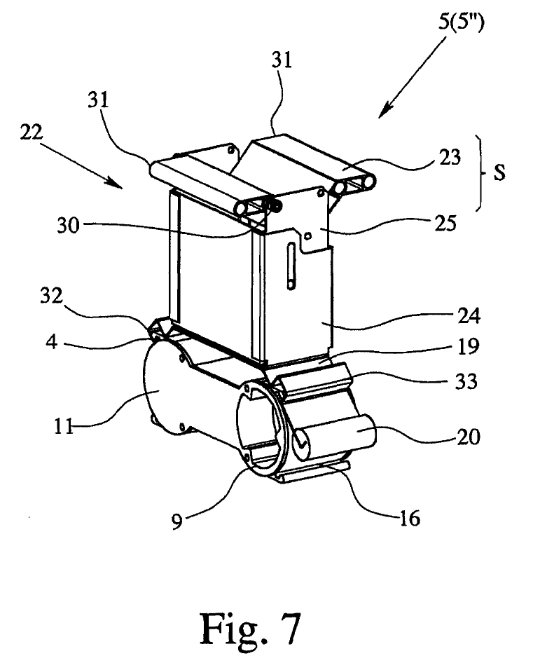

FIG. 7 shows, in a perspective view, a third exemplary embodiment of a workpiece support in the support position,

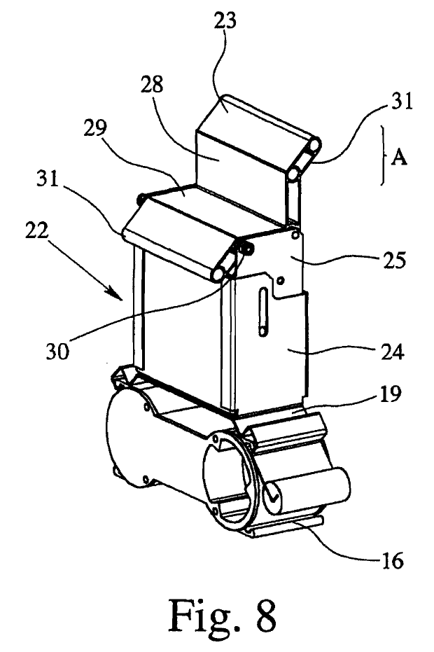

FIG. 8 shows the workpiece support from FIG. 7, in the stop position,

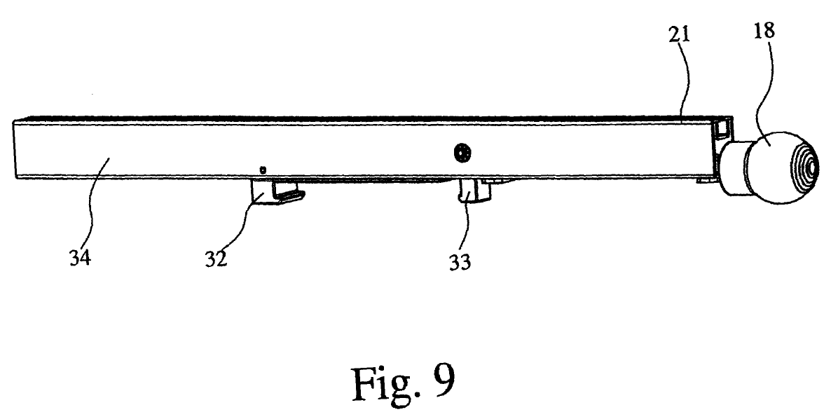

FIG. 9 shows a first exemplary embodiment of a machine holding device for a machine stand according to the invention,

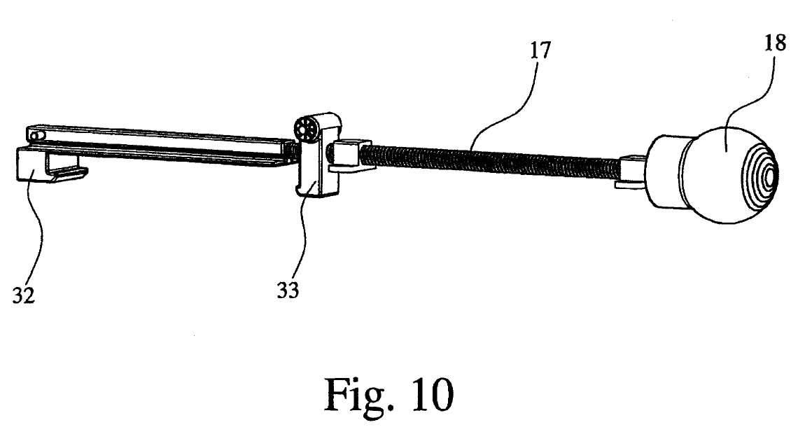

FIG. 10 shows the “inner workings” of the machine holding device from FIG. 9,

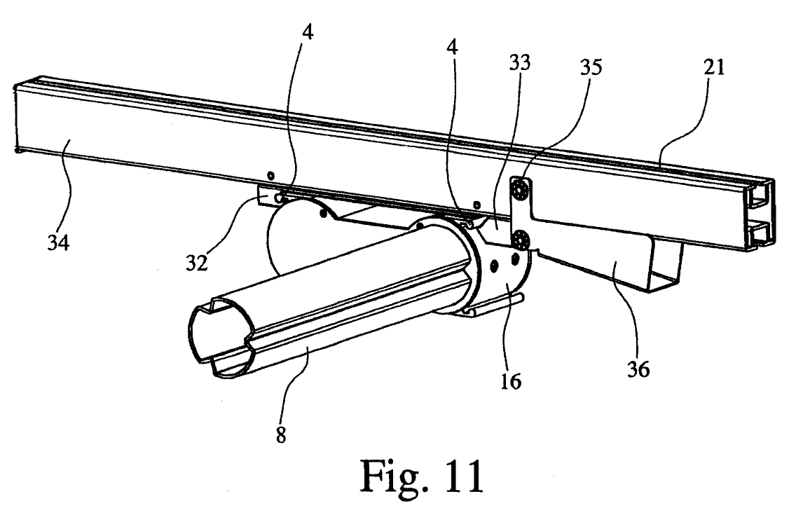

FIG. 11 shows a second exemplary embodiment of a machine holding device according to the invention,

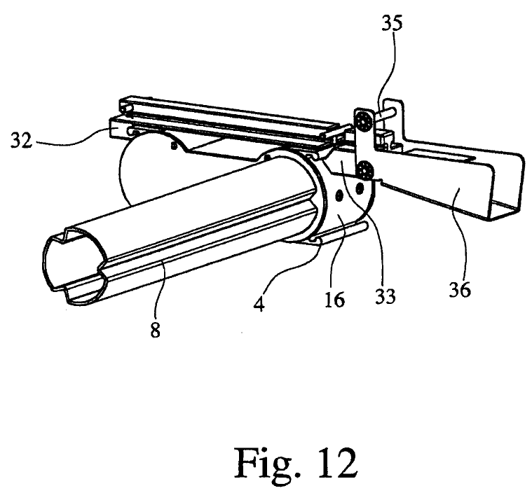

FIG. 12 shows the “inner workings” of the machine holding device from FIG. 11,

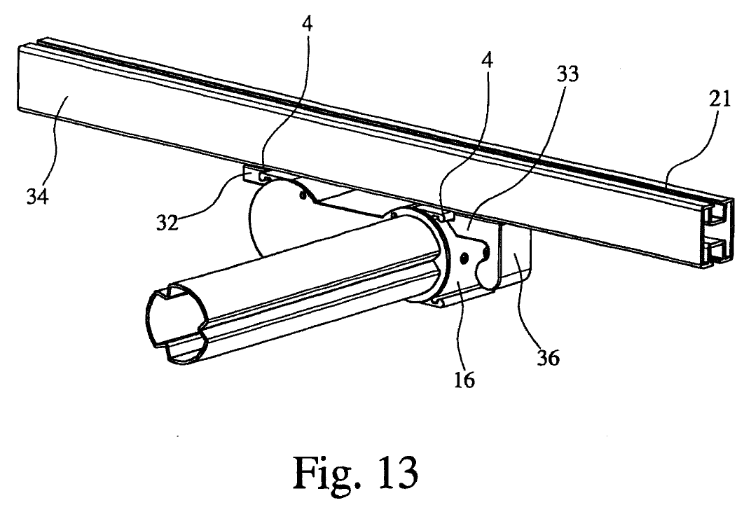

FIG. 13 shows a third exemplary embodiment of a machine holding device according to the invention,

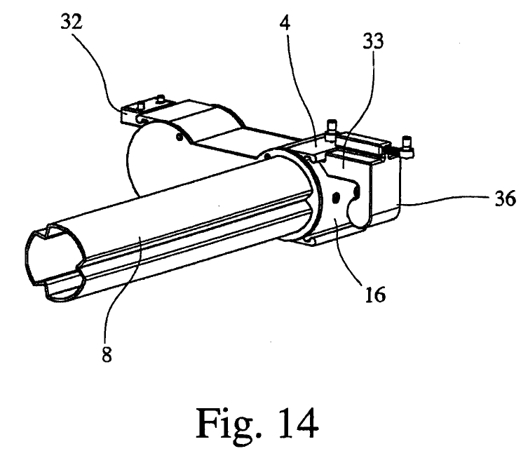

FIG. 14 shows the “inner workings” of the machine holding device from FIG. 13,

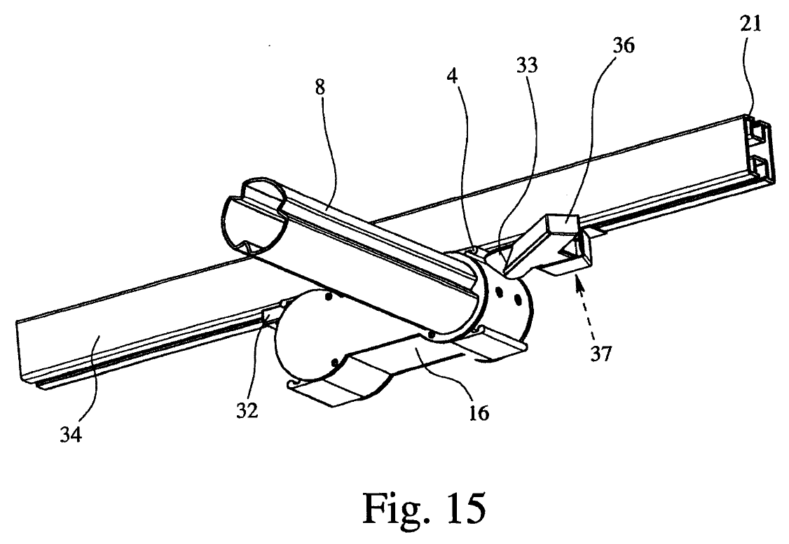

FIG. 15 shows, in a perspective view, obliquely from underneath, a fourth exemplary embodiment of a machine holding device according to the invention,

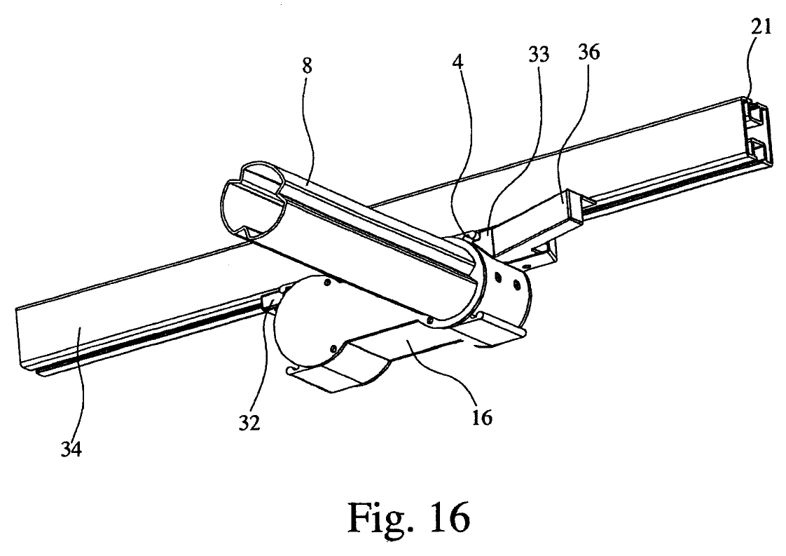

FIG. 16 shows, in a representation similar to FIG. 15, a fifth exemplary embodiment of a machine holding device according to the invention,

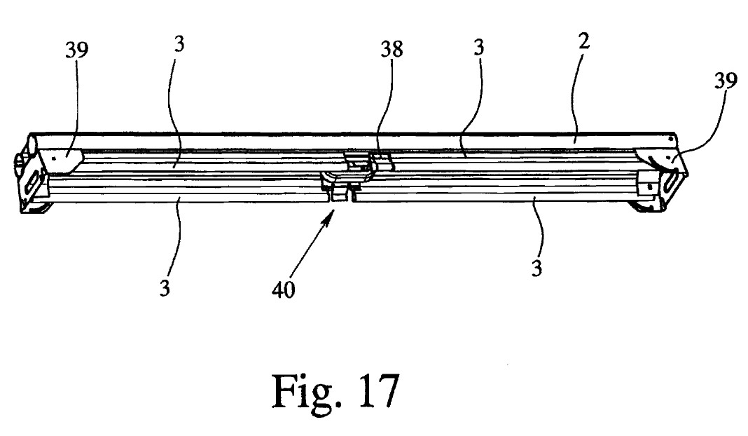

FIG. 17 shows the support body of the machine stand from FIG. 1, with folded-in support legs,

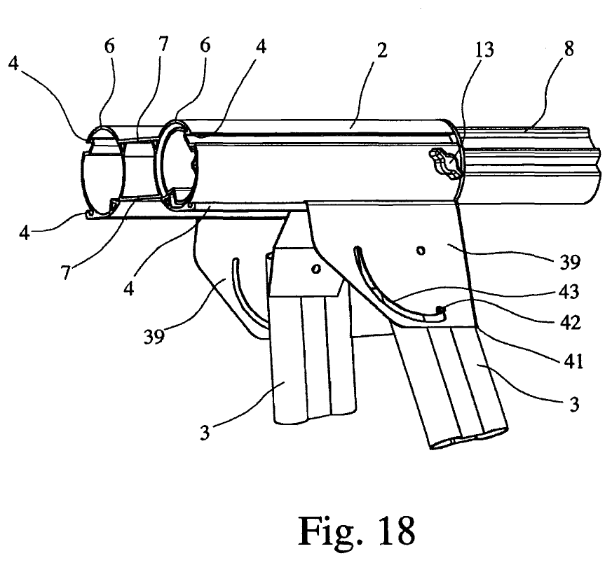

FIG. 18 shows the end of the support body of a machine stand according to the invention, in a first exemplary embodiment, with support legs in the position of use,

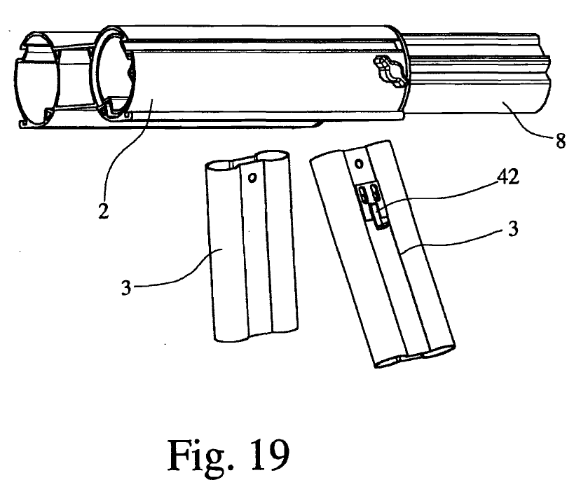

FIG. 19 shows the “inner workings” of the support-leg mounting from FIG. 18,

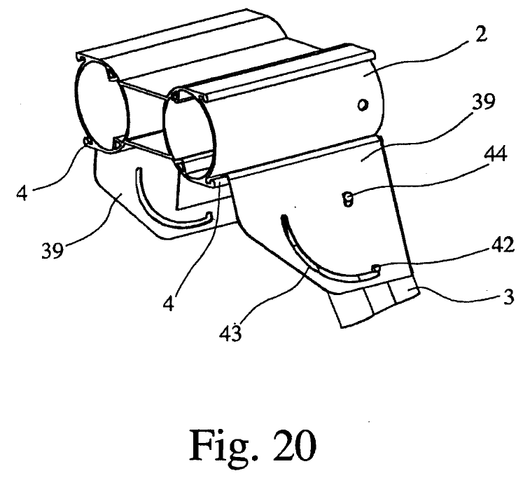

FIG. 20 shows, in a perspective view similar to FIG. 18, a second exemplary embodiment of a support-leg mounting realized according to the invention,

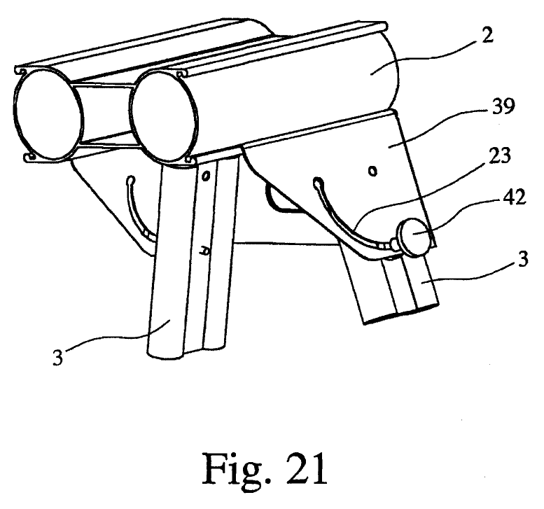

FIG. 21 shows, in a perspective view similar to FIG. 20, a third exemplary embodiment of a support-leg mounting according to the invention,

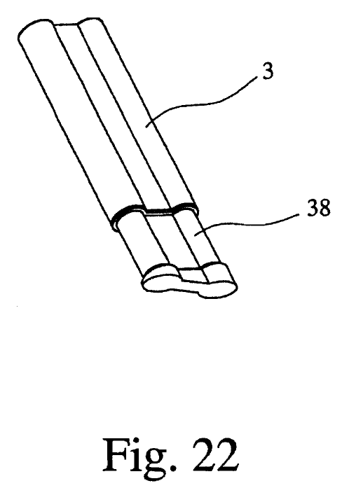

FIG. 22 shows a lower end of a support leg having an extension,

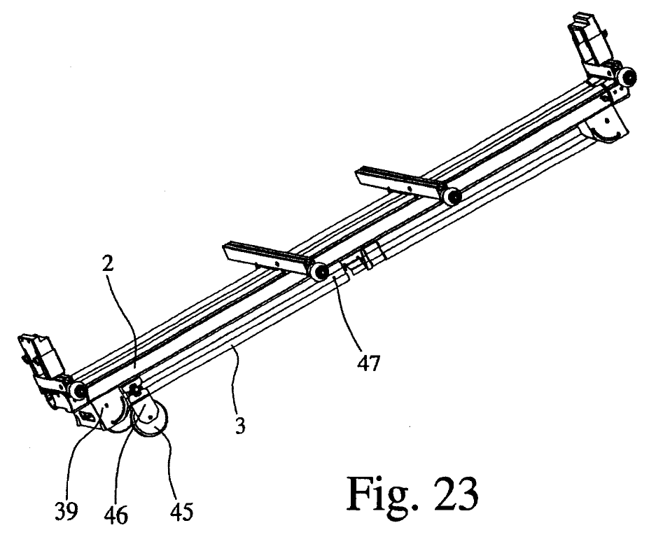

FIG. 23 shows a modified exemplary embodiment of the machine stand represented in FIG. 1 in the initial position, with folded-in support legs and transport rollers present thereon,

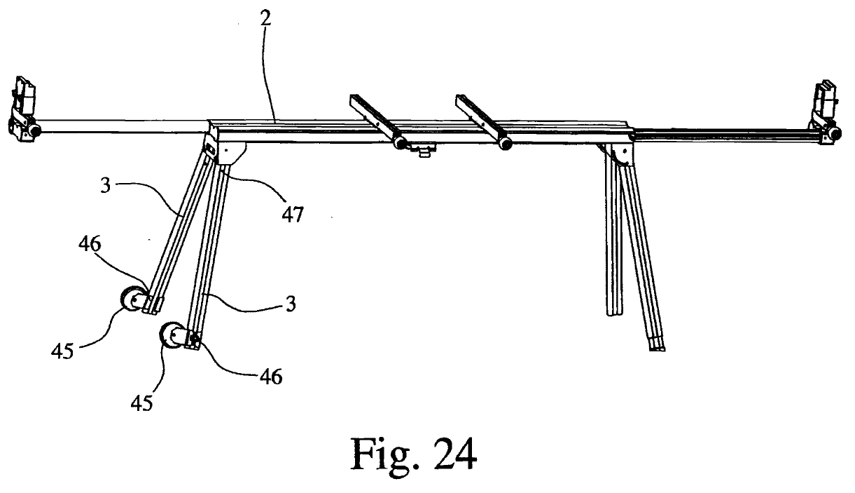

FIG. 24 shows the machine stand from FIG. 23 in the position of use,

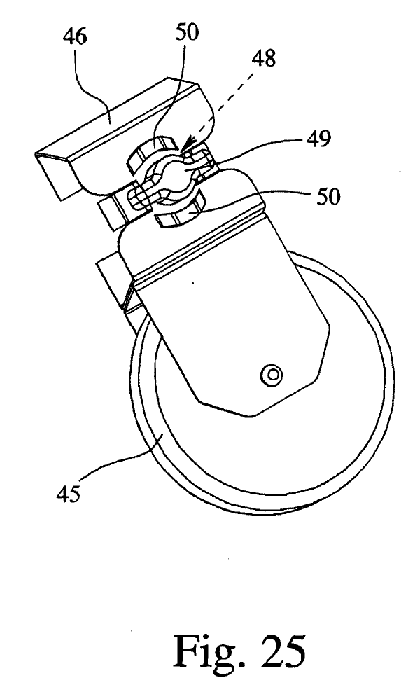

FIG. 25 shows, in a detail view, a positioning guide for a transport roller on a support leg according to FIG. 23.

The machine stand according to the invention that is represented in various exemplary embodiments in the drawings serves, to a certain extent, as a transportable work-bench for the arrangement of a power tool, in particular a miter saw 1 (FIG. 2) at a comfortable working height, for example at a work site or, in the case of interior works, at various locations in the house.

There are various possibilities, widely known from the prior art, for the arrangement of the miter saw 1 on the machine stand. Basically, in order to achieve particular additional functions, the miter saw 1 could be arranged on the machine stand such that, for its part, it is rotatable again in its entirety about a vertical axis.

Besides, it is the case that the machine stand is a universal part that can be used appropriately with any type of power tool.

The machine stand represented initially in its entirety in FIGS. 1 and 2 has an elongate support body 2, as a backbone providing structure. Support legs 3 are arranged at the ends of the support body 2. Normally, there are four support legs 3 in total, which, in the position of use, respectively project outwards in pairs, in the form of a trapezoid, at the end of the support body 2, and thus impart stability to the machine stand as a whole.

Already indicated in FIGS. 1 and 2, and shown more clearly in FIG. 3, is that the support body 2 is designed with positive fit means 4 extending in the longitudinal direction, in such a way that add-on parts 5, in particular at least one machine holding device 5′, two machine holding devices 5′ being shown in FIG. 1, can be attached thereto. The add-on parts 5 might possibly be attached to the support body 2 so as to be longitudinally displaceable. This applies, in FIGS. 1 and 2, to the machine holding devices 5′, as a result of which it is possible for the power tool, in this case the miter saw 1, to be positioned exactly centrally on the support body 2.

Many details of the machine stand according to the invention are now described in particular with reference to the further figures.

The right end of the support body 2 is represented, approximately in the center, in FIG. 3. It must thus be understood that, in the case of the representation in FIG. 3, the support body 2 continues to the left, beyond the edge of the figure.

Firstly, then, it is substantive, according to a first teaching of the invention, that the support body 2 is realized in one piece, as a double-tube profile having two profile tubes 6 extending at a lateral distance from each other and in parallel to each other, and having at least one central bridge 7 connecting the profile tubes 6. If, for the purpose of explanation, reference is made, not only to FIG. 3, but also, for example, to FIG. 20, it can be seen that, in the preferred exemplary embodiment represented, the profile tubes 6 of the double-tube profile constituting the support body 2 are connected by two central bridges 7, located one above the other and at a distance from each other.

According to a preferred teaching, the support body 2 as a whole in this case is realized as an extruded profile made of high-strength, preferably fiber-reinforced plastic, or in the exemplary embodiment represented and according to a preferred teaching, extruded as a profile from light metal, in particular aluminum. The dumb-bell shaped cross-sectional form of the support body 2 imparts to the latter, not only an excellent torsional stiffness over the full length of the support body 2, but also, in addition, a very elegant, closed appearance. Two central bridges 7 located one above the other result in there being smooth outer surfaces, and in the possibility of particularly effective cleaning of the support body 2.

The preferred exemplary embodiment represented (FIG. 3, FIG. 18, FIG. 20) further shows that the inner cross-section of the profile tubes 6 of the double-tube profile is not round. The positive fit means 4 are realized on the profile tubes 6, and are arranged so as to achieve precisely this function. In the exemplary embodiment represented, one can see (FIG. 3), on the top side of the profile tubes 6, positive fit means 4 recessed as longitudinal grooves into the top side of the profile tube 6, while outwardly projecting strip-type positive fit means 4 can be seen on the underside.

FIG. 1, already, shows the support body 2 of the machine stand extended on both sides. In FIGS. 3, 5 and 18 it can further be seen that, according to a preferred teaching, for this purpose provision is made whereby an extension tube 8, having an outer cross-section matched to the inner cross-section of the profile tube 6, is arranged in at least one profile tube 6 so as to be capable of being drawn out. An extension tube in each of the two profile tubes 6 renders possible the extension of the support body 2 towards both ends, in a “symmetrical” manner to a certain extent, as shown in FIGS. 1 and 2. The effective length for supporting elongate workpieces can thus be increased to approximately 2½ times the length of the support body 2 itself.

While the basic principle of the extension tubes 8 that can be drawn out on both sides is known per se from the prior art, it is now to be explained, with reference to FIGS. 3, 5 and 18, what is realized as special features for the extension tubes 8 in the case of the present invention. Basically, these features are to be realized irrespective of how the support body 2 is designed.

Firstly, provision is made (FIG. 18) whereby the extension tube 8 is open at the outer end and has a clear inner diameter that corresponds to a nominal outer diameter of tubes, in particular measured in inches. It is thereby possible to insert yet a further extension tube, namely to enable an extension to be made, to be realized by the user himself by means of a normal installation tube.

Even very cleanly extruded profiles have their surface irregularities. For this reason, it is disadvantageous for the extension tube 8 to be guided in a sliding manner directly in the profile tube 6 of the support body 2. In addition, the surface of the extension tube 8 would then very rapidly become unsightly. Consequently, the design according to the invention makes provision whereby a sliding contact bearing sleeve 9 is fixedly attached at the end of the profile tube 6 and a sliding contact bearing plug 10 is fixedly attached at the inner end of the extension tube 8. It is preferred in this case that the sliding contact bearing sleeve 9 and the sliding contact bearing plug 10 be composed of plastic, which is preferably provided with slide promoters. Such a slide promoter is usually an additive composed of PTFE or other admixtures incorporated in the plastic. Owing to the sliding contact bearing sleeve 9 and the sliding contact bearing plug 10, a minimum gap is created between the extension tube 8 and the profile tube 6, such that their surfaces do not slide directly on each other, but only the plastic/metal material pairing (in the case of the support body 2 being made of aluminum) occurs. Fixing of the sliding contact bearing sleeve 9 and of the sliding contact bearing plug 10 in position on the profile tube 6 and on the extension tube 8, respectively, can be effected by adhesive bonding, but in the exemplary embodiments represented it is effected mechanically, by means of pins or screws.

FIGS. 3 and 5 show very clearly that the sliding contact bearing sleeve 9, particularly when injection-molded from plastic, can be further optimized in the case of the support body 2 being realized as a double-tube profile. This is because it is shown therein that the sliding contact bearing sleeve 9 at the end of the one profile tube 6 is realized in one piece with a closing cap 11 at the end of the adjacent profile tube 6, in particular is injection-molded in one piece from plastic.

The sliding contact bearing plug 10 on the extension tube 8 in the profile tube 6 serves, at the same time, in combination with the sliding contact bearing sleeve 9 on the profile tube 6, as a stop for the drawing-out of the extension tube 8 from the profile tube 6. Normally, however, the extension tube 8 will be seated further within the profile tube 6, as indicated by FIG. 5. Otherwise, the extension tube 8 is unable feasibly to divert the bending moments acting as a load upon the extension tube even solely as a result of its own weight into the profile tube 6. It is possible for the extension tube 8 to have corresponding markings, in order to prevent the extension tube from being drawn out of the profile tube 6 too far.

Clearly, it is to be possible for the extension tube 8 to be fixed in the desired position on the profile tube 6. In the case of the preferred realization of the machine stand according to the invention, the set-screw that is typical for this purpose is integrated very elegantly into the sliding contact bearing sleeve 9. This is because, as can be seen from FIGS. 3 and 5, in this case the realization is such that the profile tube 6, at the end assigned to the sliding contact bearing sleeve 9, has a radial bore 12 for a clamping screw 13, and the sliding contact bearing sleeve 9 is provided with a threaded block 14 and a pressure distribution element 15 for the clamping screw 13. The radial bore 12 can be assumed to be under the clamping screw 13 in FIG. 3. The clamping screw 13 screwed into the threaded block 14 through the radial bore 12 can serve simultaneously to fix the sliding contact bearing sleeve 9 in position axially in the profile tube 6. Specifically in this case, however, the sliding contact bearing sleeve 9 is ensured by fastening screws that are screwed axially into screw channels of the profile tube 6. The threaded block 14 constitutes the counter-bearing for tensioning the clamping screw 13 against the extension tube 8. To prevent damage to its surface, a kind of tab is cut out of the plastic of the sliding contact bearing sleeve 9, which tab serves as a pressure distribution element 15.

FIGS. 3 to 16 show a further special feature of the machine stand according to the invention. The fastening method for add-on parts 5 on the support body 2 is also repeated here on the extension tubes 8, by means of corresponding basic carriers 16. For this purpose, provision is made whereby a basic carrier 16 for add-on parts 5 is slipped onto and fastened to the extension tube 8 at its outer end. In this case, in the preferred exemplary embodiment represented, provision is made whereby the basic carrier 16 is a short portion of the profile that also constitutes the support body 2. This means, clearly, that a short piece of a double-tube profile, such as that used for the support body 2, is used here as a basic carrier 16 for add-on parts 5.

The attaching of the basic carrier 16 to the extension tube 8 is effected in a manner corresponding to the fitting of the extension tube 8 in the profile tube 6 by means of corresponding sliding contact bearing sleeves 9. From FIG. 3 and FIG. 5 together it can be seen that, according to a preferred teaching, two sliding contact bearing sleeves 9 are provided here, one on each side of the basic carrier 16. Here, both sliding contact bearing sleeves 9 are permanently fixed to the basic carrier 16 by means of countersunk screws.

The desired add-on parts 5 can be fastened to the basic carrier 16, as to the support body 2 itself.

According to a particularly preferred and independent teaching, it can be seen that a workpiece support 5″ is provided as an add-on part 5 and can be fixed in position by means of a screw clamping or spring-force clamping, via the positive fit means 4 on the support body 2 and on the basic carrier 16. Provision can be made in this case whereby the workpiece support 5″ is composed of sheet-metal formed parts and/or of plastic formed parts.

The exemplary embodiments according to FIGS. 3-6 show workpiece supports 5″ having screw clamping by means of a threaded rod 17 and rotary knob 18. The exemplary embodiments of FIGS. 7 and 8 show a spring-force clamping by means of a basic body 19, composed of spring steel, on the end of which, on the right in FIGS. 7 and 8, a handle 20 can be seen, as a kind of bead.

The screw clamping by means of rotary knob 18 and threaded rod 17 is also a very expedient solution in the case of the machine holding device 5′. The clamping of the machine holding device 5′ on the support body 2 can be adjusted with precision by turning the rotary knob 18 several times until the fixing position is attained.

The workpiece support 5″ represented in these exemplary embodiments has a basic body 19. Here, the latter also includes or constitutes a clamping mechanism. In this regard, it can be seen in FIGS. 3, 4 and 6 that a fastening rail 21, extending transversely relative to the support body 2, is provided on the basic body 19.

FIG. 4 shows an exemplary embodiment of a workpiece support 5″ in which provision is made whereby a support element 22, having a height-adjustable rest 23 for a workpiece, is fastened to the basic body 19, in particular to its fastening rail 21.

The preferred exemplary embodiment represented in FIG. 4 shows that, here, the support element 22 has a lower part 24, and has an upper part 25 that is height-adjustable relative to the latter and comprises the rest 23. It can be seen in this case that, for the purpose of height adjustment, the upper part 25 can be displaced vertically relative to the lower part 24. On the lower part 24 one can see a rotary knob 26, by means of which a clamping mechanism can be operated, for the purpose of moving the support element 22 laterally on the fastening rail 21. In addition, one can see in FIG. 4, on the back of the lower part 24, a further rotary knob 27 for adjusting the height of the upper part 25 relative to the lower part 24. A further rotary knob, which is concealed, is arranged to the left of the latter rotary knob.

The exemplary embodiment that is represented in FIG. 4, and to this extent preferred, furthermore shows that, located in front of the rest 23 of the upper part 25, there is a step, whose vertically extending surface 28 constitutes a longitudinal stop, and whose horizontal surface located in front of said surface constitutes a second rest 29 for a workpiece. In a lower position, the workpiece support 5″ according to FIG. 4 acts only as a rest for the workpiece. In a raised position, by contrast, the vertically aligned surface 28 becomes effective as a longitudinal stop for the workpiece. The workpiece then no longer lies on the rest 23, but on the second rest 29, which is arranged with a downward offset, owing to the vertically extending surface 28.

The further exemplary embodiment of a workpiece support 5″, represented in FIG. 6, shows particularly clearly, firstly, the fastening rail 21 with the rotary knob 18 and, on the fastening rail 21, the support element 22 with the lower part 24 and the upper part 25 that is height-adjustable relative thereto (the rotary knobs 27 on the right and left). Here, a supporting roll serves as a rest 23.

A further, and particularly interesting, exemplary embodiment of a workpiece support 5″ is represented in FIGS. 7 and 8. Not absolutely necessary, but realized here, is an upper part 25 that is vertically adjustable relative to the lower part 24. Here, however, provision is made whereby the rest 23 is realized on an angle arrangement, which is pivotable about a pivot axis 30 extending horizontally and transversely relative to the support body 2, and which can be fixed on the support element 22, in particular on its upper part 25, in a support position S, on the one hand and, on the other hand, in a stop position A that is offset by 45° relative thereto. FIG. 7 shows the support position S, FIG. 8 shows the stop position A pivoted by 45° relative thereto. This workpiece support 5″ can be “changed over” to a certain extent by a simple pivoting adjustment.

In the exemplary embodiment represented, provision is made whereby fixing of the angle arrangement in the support position S is effected by a stop on one side. Further, provision can be made whereby fixing of the angle arrangement in the stop position A is effected by a latch or a fixing pin.

Finally, it can be seen particularly clearly from FIG. 7 that, in the preferred exemplary embodiment represented here, the angle arrangement is provided with support flanges 31, which lie horizontally in the support position S and constitute the rest 23, and/or that a second rest 29, which is offset by 45° relative to the first rest 23, comes into effect in the stop position A. Thus, in the position according to FIG. 7, one has a clear, large-area rest for an elongate workpiece, whereas a likewise rectilinear stop, with a second rest 29 acting there, is provided in the position of FIG. 8.

As already realized in the prior art, provision can be made whereby two machine holding devices 5′, arranged in pararell to each other and transversely relative to the support body 2, are provided for attaching a machine, in particular a miter saw. This can be seen in FIGS. 1 and 2 in combination.

For all add-on parts 5, i.e. both for the machine holding devices 5′ and for the workpiece supports 5″, one can work with the techniques, explained more fully in the following, for attachment to the support body 2, or to its positive fit means 4.

Basically, provision can be made whereby the add-on part 5 can be fixed to the support body 2 by means of a clamping mechanism, via the positive fit means 4, and the clamping mechanism, in particular on a basic profile 34, has a fixed clamping jaw 32 and a clamping jaw 33 that is adjustable relative thereto. Such clamping jaws 32, 33 can be seen in the case of the workpiece supports 5″ according to FIGS. 3-8 and in the case of the machine holding devices 5′ according to FIG. 9 ff. The design variants are to be explained in detail with reference to the machine holding devices 5′, which are represented from FIG. 9 onwards.

In the case of the exemplary embodiment represented in FIGS. 9 and 10 (which corresponds to the exemplary embodiment of the workpiece support 5″ according to FIGS. 3-6), it is the case that the adjustable clamping jaw 33 is mounted on the basic profile 34 of the add-on part 5 so as to be pivotable about a horizontal axis. Further, it can be seen that the adjustable clamping jaw 33 is adjustable by means of a threaded rod 17 mounted in the basic profile 34.

In the case of the exemplary embodiment of an add-on part 5, in particular of a machine holding device 5′, that is represented in FIGS. 11 and 12, it is the case, by contrast, that the adjustable clamping jaw 33 is mounted on the basic profile 34 so as to be displaceable transversely relative to the support body 2, is spring-biased in the fixing direction and can be drawn back, against the spring force, by means of a hand lever 36 that is mounted on the basic profile 34 so as to be pivotable about a horizontal axis 35 or mounted so as to be displaceable on the basic profile 34.

The second variant mentioned, having the displaceably mounted hand lever 36, is shown by the exemplary embodiment represented in FIGS. 13 and 14. Substantive in all cases is that the lug of the adjustable clamping jaw 33 engages securely in the associated positive fit means on the support body 2, or on the basic carrier 16 on the extension tube 8. The requirements for this are naturally greater in the case of the machine holding device 5′ than in the case of the workpiece support 5″, since the machine holding device 5′ must withstand substantially greater loads. The dimensions and spring forces are matched to these requirements.

In the case of the exemplary embodiment represented in FIG. 15, it is the case that the adjustable clamping jaw 33 is mounted on the basic profile 34 so as to be pivotable about a vertical axis 37 and can be pivoted laterally, in the form of an arc, into the fixing position on the support body 2. Upon actuation of the hand lever 36, the outer, eccentric contour of the adjustable clamping jaw 33 rotates away from the positive fit means 4 of the support body 2, such that the machine holding device 5′ can be removed. The spring biasing in the engagement direction is generated by a leaf spring in the mounting of the hand lever 36.

In the case of the further exemplary embodiment represented in FIG. 16, the actuation is effected in a manner similar to that in the case of the exemplary embodiment of FIG. 15, but the clamping on the positive fit means 4 is effected by means of a small clamping lug. Moreover, provision can also be made whereby the adjustable clamping jaw 33 is pivotable only by manual actuation and without spring-force action, and is latched at least in the fixing position.

In FIGS. 11 to 16, for reasons of greater clarity the machine holding devices 5′ have been represented as add-on parts 5 on a basic carrier 16, not on the support body 2 itself, although the machine holding devices 5′ per se are arranged approximately centrally on the support body 2, as can be seen from FIG. 1. For mounting on the support body 2 itself, precisely the same is applicable.

Moreover, FIGS. 11 to 16 show the extent of the clear appearance of the basic carrier 16 at the end of the extension tube 8, owing to the closing cap 11 on both sides. Finally, the said figures show that the fastening rail 21 is realized, quite particularly expediently, as an extruded profile of fiber-reinforced plastic or, in particular, of a light metal, in particular aluminum, and on the top side and underside has the same T-groove, in which corresponding slide blocks then run for fastening purposes.

FIGS. 1 and 2, already, show the support legs 3 on the support body 2. FIGS. 17 to 25 now show exemplary embodiments that relate to the support legs 3 of the machine stand.

FIGS. 18 and 22 show clearly that, in the preferred exemplary embodiment represented here, each support leg 3 is designed externally as a kind of double-tube profile, such that it has the appearance of a dumb-bell shape. On the inside, however, there are no profile tubes extending in parellel to each other, there being instead a through cavity. FIG. 22 shows that there is thereby created the possibility of an extension 38, which can be drawn out and fixed in position, being arranged at the end of at least one support leg 3. Clearly, in addition, the rubber feet already known in the prior art, or corresponding foot parts, can also be easily mounted on the support legs 3 and the extension 38.

If one has only one extension 38, then the machine stand has a certain working height when in the position of use. The extension 38 only enables irregularities of the floor to be compensated. If one has extensions 38 on all support legs 3, one can thereby also set the working height of the machine stand as a whole to desired values, in order thus to take account of differing body sizes of the users.

As already provided for in the prior art, it is also the case here that two support legs 3 are arranged at each end of the support body 2, and each support leg 3 is fastened to the support body 2 by means of a support-leg mounting 39. Various variants of the support-leg mountings 39 are now to be explained in the following.

Firstly, it is the case, in general, that each support leg 3 is pivotably mounted by means of the support-leg mounting 39, such that it can be pivoted out of an initial position having an orientation that is approximately parallel to the support body 2, into a position of use having an orientation downwards and outwards relative to the support body 2, and vice versa. This corresponds to the designs realized throughout the prior art.

Basically, however, it is to be noted that the design and fastening of the support legs 3 are entirely independent of how the machine stand is designed in other respects. In particular, individually removable and interchangeable support legs 3 could also be used for the design variants already described above.

Here, in contrast with the prior art, in the case of the pivotably hinged support legs 3 provision is not made for fixing in the initial position in the region of the support-leg mountings 39. Rather, in the exemplary embodiment represented (FIG. 17), provision is made whereby mounted centrally on the underside of the support body 2 there is a retaining arrangement 40, in which the lower ends of the support legs 3 are locked in place when in the initial position, and from which the support legs 3 can be released by the pressing of a button. This retaining arrangement 40 consists, in particular, of a correspondingly shaped spring-steel body, in which the profiles of the support legs 3, having a dumb-bell type shape, can be locked in place very easily and reliably, as shown by FIG. 17. The retaining arrangement 40 is released by the pressing of a button, such that, while the support body 2 is being held up, all four support legs 3 can pivot simultaneously into their position of use, and lock therein, without further intervention by the user. Other designs, e.g. of plastic or with the use of magnets, can also be provided.

If one has support legs 3 that can be varied in their length, then, by displacing the end support-leg mountings 39 longitudinally on the support body 2 and re-fixing them on the support body 2 in a position correspondingly displaced in the longitudinal direction, one can achieve a situation in which the retaining arrangement 40 always remains effective in the center of the support body 2.

Common to all of the exemplary embodiments represented in FIGS. 18 to 21 is that each support leg 3, at least in the position of use, bears on a stop 41 of the support-leg mounting 39, and is locked there. In the case of the simultaneous pivoting of the support legs 3 from the initial position into the position of use, in particular, the support legs 3 pivot by themselves onto the stops 41.

Moreover, common to the two exemplary embodiments represented in FIGS. 18 to 20 is that the support leg 3 is provided with a locking element 42 that runs on or in an arcuate track 43 in the support-leg mounting 39, the ends of which track correspond with the end positions of the support leg 3. There is a multiplicity of suggestions in the prior art for the design of such locking elements 42. In the exemplary embodiments represented, the arrangement of the track 43 is always shown completely enclosed in the lateral metal plate of the support-leg mounting 39. Alternatives having an edge track are to be found in the prior art.

The exemplary embodiment represented in FIGS. 18 and 19 discloses the special feature whereby the locking element 42 is spring-biased into the locked position, in particular upwards in the direction of the support body 2, in particular whereby the locking element 42 is realized as a spring-biased slide on the support leg 3. The locked-in-place end position, which corresponds to the position of use of the support leg 3, can be seen in FIG. 18.

By contrast, in the case of the exemplary embodiment represented in FIG. 21, there is the special feature whereby the locking element 42 is realized as a spring-loaded pull-knob or as a threaded knob, and the locking of the support leg 3 is effected by locking of the pull-knob in place or tightening the threaded knob. The exemplary embodiment represented in FIG. 21 shows a pull-knob, as a locking element 42, spring-loaded in the engagement direction. The track 43 there is also seen to have a widening at the left end, such that the locking element 42 can also be locked in place therein. If the track 43 is continuous, i.e. has no widening at this end, no locking is also effected when the support leg 3 is in the initial position. Correspondingly, the entire system could also be realized with, as a locking element 42, a threaded knob that can be tightened.

The exemplary embodiment outlined in FIG. 20 has a yet further, different design, such that the pivot axis 44 of the support leg 3 is itself mounted so as to be capable of slight longitudinal displacement on the support-leg mounting 39, in particular in an oblong slot. In the position of use, the support leg 3 is displaced upwards in the direction of the support body 2, in particular by spring force, and at the same time the locking element 42 is locked in place on the support-leg mounting 39.

As has already been realized in the prior art, likewise in the case of the exemplary embodiments of the machine stand according to the invention that are represented here, realization is such that the two support-leg mountings 39 are realized in one piece with each other, as a bracket, at one end of the support body 2. The bracket in this case is made, expediently, of folded and stove-enameled sheet metal.

The fastening of the bracket, or of the support-leg mountings 39 combined in the bracket, to the support body 2 is effected, expediently, such that there are arranged on the underside of the support body 2 preferably outwardly facing, strip-type positive fit means 4, into an outside face of which matching guide means on the support-leg mountings 39, or on the bracket, can be inserted by sliding. This sliding option has already been discussed above.

Finally, the representations in FIGS. 23 to 25 illustrate a further particularly preferred design of the machine stand according to the invention, which is characterized in that a transport roller 45 is arranged on each of the support legs 3 arranged at one end of the support body 2, said transport roller 45, when the support leg 3 is in the position of use, being located close to the lower end of the latter and projecting approximately in the longitudinal direction from the support leg 3. Transport rollers 45 are known per se from the prior art for machine stands of the type under consideration. Transport rollers 45 projecting approximately in the longitudinal direction from support legs 3 are standard for construction circular saws and larger bench circular saws. The transport rollers 45 can thus be brought to the floor by tilting the support frame, such that the support frame, together with the power tool, can be rolled away sideways with relative ease. The teaching also realizes this concept in the case of the present machine stand.

In the present case, however, the special feature consists in that the transport roller 45 can be placed close to the lower end on the support leg 3 when in a position of use, and placed close to the end on the support body side when in a transport position. The differing positions of the transport rollers 45 on the two support legs 3 concerned can be seen through comparison of FIG. 23 and FIG. 24. Thus, even the folded-up machine stand can actually be pulled extremely well by means of the support legs 3 in the initial position (FIG. 23).

FIG. 25 shows details of a positioning mounting 46 on the support leg 3. It can be seen that the transport roller 45 is attached to the support leg 3 by means of a positioning mounting 46, and is displaceable in the longitudinal direction of the support leg 3 and can be fixed in position on the support leg 3 both in its position of use and in its transport position. Further, it can be seen in this case that the support leg 3 has a bore 47 where the positioning mounting 46 is in the position of use, and also where it is in the transport position, and that the positioning mounting 46 is provided with a spring-loaded pin 48 that can be locked in place in the bore 47. (In FIGS. 23 and 24, the bore 47 is indicated at the respectively “unoccupied” end, since in FIG. 25 it is naturally concealed by the positioning mounting 46).

The special feature of the design in FIG. 25 consists in that the pin 48 is rotatable by means of a knob 49 or the like, the positioning mounting 46 has a control contour 50 and, by means of the control contour 50, through rotation of the knob 49, the pin 48 can be drawn out of the bore 47, against the action of spring force, transversely relative to the support leg 3. If, in the case of the representation in FIG. 25, the knob 49 is rotated by 90°, the pin 48 located beneath it is drawn out of the bore 47, located beneath it, in the central bridge of the support leg 3. The positioning mounting 46, with the transport roller 45, can now be pushed into the other position on the profile of the support leg 3. If the knob 49 is now rotated back to the position represented in FIG. 25, the pin 48 snaps into the bore 47 there, under spring force, and the positioning mounting 46 is fixed in position at the other end of the support leg 3.

In this way, it can be ensured, by means of the positioning mounting 46, that the transport rollers 45 are always seated at the optimum position for the respective transport task.

1-55. (canceled)

56. A machine stand comprising an elongate support body and support legs arranged at the ends of the support body, the support body comprising positive fit means extending in the longitudinal direction in such a way that add-on parts, including at least one machine holding device, can be attached thereto, wherein two support legs are arranged at each end of the support body and each support leg is fastened to the support body by a support-leg mounting.

57. The machine stand as claimed in claim 56, wherein each support leg is pivotably mounted via the support-leg mounting, such that it can be pivoted out of an initial position having an orientation that is approximately parallel to the support body, into a position of use having an orientation downwards and outwards relative to the support body, and vice versa.

58. The machine stand as claimed in claim 57, wherein mounted centrally on the underside of the support body there is a retaining arrangement in which the lower ends of the support legs are locked in place when in the initial position, and from which the support legs can be released by a central manipulation, the central retaining arrangement comprising a spring-steel arrangement.

59. The machine stand as claimed in claim 56, wherein each support leg, at least in the position of use, bears on a stop of the support-leg mounting and is locked there.

60. The machine stand as claimed in claim 56, wherein the support leg is provided with a locking element that runs on or in an arcuate track in the support-leg mounting, the ends of which track correspond with the end positions of the support leg.

61. The machine stand as claimed in claim 60, wherein the locking element is spring-biased into the locked position, which is upwards in the direction of the support body, wherein the locking element comprises a spring-biased slide on the support leg.

62. The machine stand as claimed in claim 60, wherein the locking element comprises a spring-loaded pull-knob and wherein the locking of the support leg is effected by locking the pull-knob in place.

63. The machine stand as claimed in claim 60, wherein the pivot axis of the support leg is itself mounted so as to be capable of slight longitudinal displacement on the support-leg mounting, in particular in an oblong slot, wherein in the position of use the support leg is displaced upwards in the direction of the support body and at the same time the locking element is locked in place on the support-leg mounting.

64. The machine stand as claimed in claim 56, wherein the two support-leg mountings comprise one piece with each other, as a bracket, at one end of the support body.

65. The machine stand as claimed in claim 64, wherein the bracket is made of sheet metal.

66. The machine stand as claimed in claim 56, wherein arranged on the underside of the support body there are outwardly facing, strip-type positive fit means, into an outside face of which matching guide means can be inserted by sliding.

67. The machine stand as claimed in claim 56, wherein a transport roller is arranged on each of the support legs arranged at one end of the support body, said transport roller, when the support leg is in the position of use, being located close to the lower end of the latter and projecting approximately in the longitudinal direction from the support leg.

68. The machine stand as claimed in claim 67, wherein the transport roller is configured so as to be placed close to the lower end on the support leg when in a position of use, and placed close to the end on the support body side when in a transport position.

69. The machine stand as claimed in claim 68, wherein the transport roller is attached to the support leg by a positioning mounting, and is displaceable in the longitudinal direction of the support leg and can be fixed in position on the support leg both in its position of use and in its transport position.

70. The machine stand as claimed in claim 69, wherein the support leg has a bore where the positioning mounting is in the position of use, and also where it is in the transport position, and wherein the positioning mounting is provided with a spring-loaded pin that can be locked in place in the bore.

71. The machine stand as claimed in claim 60, wherein the locking element is a threaded knob, and wherein locking of the support leg is effected by tightening the threaded knob.

72. The machine stand as claimed in claim 66, wherein the matching guide means are on the support leg mountings.

73. The machine stand as claimed in claim 66, wherein the matching guide means are on the bracket.

74. The machine stand as claimed in claim 70, wherein the pin is rotatable by a knob.

75. The machine stand as claimed in claim 74, wherein the positioning mounting has a control contour and wherein by means of the control contour, through rotation of the knob, the pin is configured to be drawn out of the bore, against the action of spring force, transversely relative to the support leg.
